(19) United States
(12) Patent Application Publication
(10) Pub. No.: US 2010/0232137 A1
(43) Pub. Date: Sep. 16, 2010

(54) COMPOSITE OPTICAL FILM AND FLAT LIGHT SOURCE MODULE

(75) Inventors: Chi-Hung Liao, Tainan City (TW); Hui-Hsiung Lin, Hsinchu County (TW); Tsung-Hsin Lin, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/495,823

(22) Filed: Jul. 1, 2009

(30) Foreign Application Priority Data
Mar. 10, 2009 (TW) 98107689

(51) Int. Cl. G09F 13/04; G02B 27/10; F21V 5/02

(52) U.S. Cl. 362/97.1; 359/619; 362/311.06

(57) ABSTRACT

A composite optical film including a base and an optical-field-modulation microstructure layer is provided. The base has a light incident surface and a light emitting surface, wherein the light incident surface and the light emitting surface are correspondingly disposed. The optical-field-modulation microstructure layer disposed on the light emitting surface has a first prism column set and a second prism column set, wherein the first prism column set has a plurality of first prism columns arranged in parallel and extended along a first direction, and the second prism column set has a plurality of second prism columns arranged in parallel and extended along a second direction. The first prism column set and the second prism column set are disposed across each other, and at least one of the first prism column set and the second prism column set has a smooth curve top.

### CROSS-REFERENCE TO RELATED APPLICATION

This application claims the priority benefit of Taiwan application serial no. 98107689, filed on Mar. 10, 2009. The entirety of the above-mentioned patent application is hereby incorporated by reference herein and made a part of specification.

### BACKGROUND OF THE INVENTION

1. Field of the Invention

The present invention generally relates to a composite optical film and a flat light source module thereof, and more particularly, to a composite optical film having an optical-field-modulation microstructure layer.

2. Description of Related Art

Liquid crystal display (LCD) has been broadly applied to personal computers and other image display products. Because a LCD is a passive display device, a flat light source has to be disposed behind the liquid crystal surface for providing display illumination. The flat light source should provide a light beam with predetermined diffusion and uniform brightness such that images can be clearly displayed on the liquid crystal surface.

Accordingly, the light source and the optical film set should be taken into consideration in the design of a backlight module. The light source allows the displayed images to be visible, and the optical film set disposed above the light source converts a point light source into a uniform flat light source. Light sources adopted in backlight modules include cold cathode fluorescent lamp (CCFL), light emitting diode (LED), small molecule organic light emitting diode (SMOLED), polymer light emitting diode (PLED), electro luminescent (EL), and fluorescent flat light (FFL), etc. In addition, the optical film disposed above the light source may be a light guide plate, a lower diffuser, a collector, an upper diffuser, a polarimetric reflector, and a wide view film, etc. Such features of the optical film as light diffusion, light collection, and the capability for preventing the luminous intensity from decreasing along with the increase of the viewing angle should be taken into consideration.

Two prism sheets are usually disposed in a small-sized LCD panel for enhancing the luminous intensity at the right viewing angle, wherein the two prism sheets respectively have a 90° vertex angle and are disposed across each other. However, such a design may cause the luminous intensity to change drastically at large viewing angles. In addition, a single prism sheet is usually disposed in a large-sized LCD panel for controlling and guiding light beams so that the light beams can be concentrated around the right viewing angle and accordingly the luminous intensity at the right viewing angle can be increased. Even though the light beams can be collected by adopting such a conventional structure, the luminous intensity may decrease to about zero when the viewing angle exceeds 60°, and the luminous intensity along the other axis also changes drastically at large viewing angles.

A “lighting panel with opposed 45° corrugations” is disclosed in U.S. Pat. No. 4,542,449. Two prism structures are attached together for controlling and guiding light beams, so as to concentrate the light beams and increase the luminous intensity at the right viewing angle. However, even though light beams can be effectively collected through such a structure, they cannot be diffused, and besides, the luminous intensity also changes drastically at large viewing angles.

Some other conventional optical film set designs have also been provided. However, none of these conventional techniques is satisfactory enough. Thereby, a more satisfactory optical film set and the light source thereof are still to be provided.

### SUMMARY OF THE INVENTION

Accordingly, the present invention is directed to a composite optical film, wherein such features as light diffusion, light collection, and luminous intensity/viewing angle distribution of the composite optical film are controlled through changes in a microstructure, so that the light utilization efficiency can be improved and the structure complexity and the cost of a light source module can be reduced.

The present invention provides a composite optical film including a base and an optical-field-modulation microstructure layer. The base has a light incident surface and a light emitting surface, wherein the light incident surface and the light emitting surface are correspondingly disposed. The optical-field-modulation microstructure layer disposed on the light emitting surface has a first prism column set and a second prism column set. The first prism column set has a plurality of first prism columns arranged in parallel and extended along a first direction, and the second prism column set has a plurality of second prism columns arranged in parallel and extended along a second direction. The first prism column set and the second prism column set are disposed across each other, and at least one of the first prism column set and the second prism column set has a smooth curve top.

The present invention further provides a flat light source module including a backlight source unit and a composite optical film. The backlight source unit provides a flat light source. The composite optical film is disposed at one side of the backlight source unit for directly or indirectly receiving the flat light source. The composite optical film includes a base, a first prism column set, and a second prism column set. The base has a light incident surface and a light emitting surface, wherein the light incident surface and the light emitting surface are correspondingly disposed, and the light incident surface faces the backlight source unit. The first prism column set has a plurality of first prism columns located on the light emitting surface, wherein the first prism columns are arranged in parallel and extended along a first direction. The second prism column set has a plurality of second prism columns located on the light emitting surface, wherein the second prism columns are arranged in parallel and extended along a second direction. The first prism column set and the second prism column set are disposed across each other, and at least one of the first prism column set and the second prism column set has a smooth curve top.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a liquid crystal display (LCD) device according to an embodiment of the present invention.

FIG. 2 is a diagram illustrating how a prism refracts an incident light.

FIG. 3 is a diagram illustrating how a prism-like structure having a smooth curve top refracts an incident light according to an embodiment of the present invention.

FIG. 4 is a perspective view of a composite optical film according to an embodiment of the present invention.

FIG. 5 is a perspective view of a composite optical film according to an embodiment of the present invention.

FIG. 6 is a cross-sectional view of an aspheric curve according to an embodiment of the present invention.

FIG. 7 is a perspective view of a mold insert according to an embodiment of the present invention.

FIG. 8 is a perspective view illustrating how to fabricate a film through a roll-to-roll method according to an embodiment of the present invention.

FIG. 9A is a cross-sectional view of an image display device having a composite optical film according to an embodiment of the present invention.

FIG. 9B is a diagram illustrating the luminous intensity/viewing angle distribution of the image display device in FIG. 9A.

FIG. 10A is a cross-sectional view of an image display device having a composite optical film according to an embodiment of the present invention.

FIG. 10B is a diagram illustrating the luminous intensity/viewing angle distribution of the image display device in FIG. 10A.

FIG. 11A is a cross-sectional view of an image display device having a composite optical plate according to an embodiment of the present invention.

FIG. 11B is a diagram illustrating the luminous intensity/viewing angle distribution of the image display device in FIG. 11A.

FIG. 12A is a cross-sectional view of an image display device having a composite optical plate according to an embodiment of the present invention.

FIG. 12B is a diagram illustrating the luminous intensity/viewing angle distribution of the image display device in FIG. 12A.

### DESCRIPTION OF THE EMBODIMENTS

Reference will now be made in detail to the present exemplary embodiments of the invention, examples of which are illustrated in the accompanying drawings. Wherever possible, the same reference numbers are used in the drawings and the description to refer to the same or like parts.

The present invention provides a composite optical film including a base and an optical-field-modulation microstructure layer. The base has a light incident surface and a light emitting surface, wherein the light incident surface and the light emitting surface are correspondingly disposed. The optical-field-modulation microstructure layer is disposed on the light emitting surface and is fabricated of a transmissive material. The optical-field-modulation microstructure layer is composed of dual-axis prism columns including a first prism column set and a second prism column set, wherein the first prism column set has a plurality of first prism columns arranged in parallel and extended along a first direction, and the second prism column set has a plurality of second prism columns arranged in parallel and extended along a second direction. The first prism column set and the second prism column set are disposed across each other. Each of the prism column sets may have a smooth curve top, such as an aspheric top, therefore may also be referred to as a prism-like column. Accordingly, the optical film can diffuse and collect an incident light and prevent the luminous intensity from decreasing along with the increase of the viewing angle. Besides, the light diffusion, light collection, and luminous intensity/viewing angle distribution of the optical device can be adjusted by adjusting the angle formed by the two axes, the height, and the pitch ratio of the dual-axis prism columns having the aspheric curve top, so that the problem that the luminous intensity changes drastically at large viewing angles when a single prism sheet is adopted can be resolved. In addition, according to the present invention, the conventional problem that the luminous intensity along the other axis decreases to zero when the viewing angle exceeds 60° can also be resolved.

Embodiments of the present invention will be described below with reference to accompanying drawings. However, these embodiments are not intended for limiting the present invention and can be combined appropriately to produce some other embodiments of the present invention.

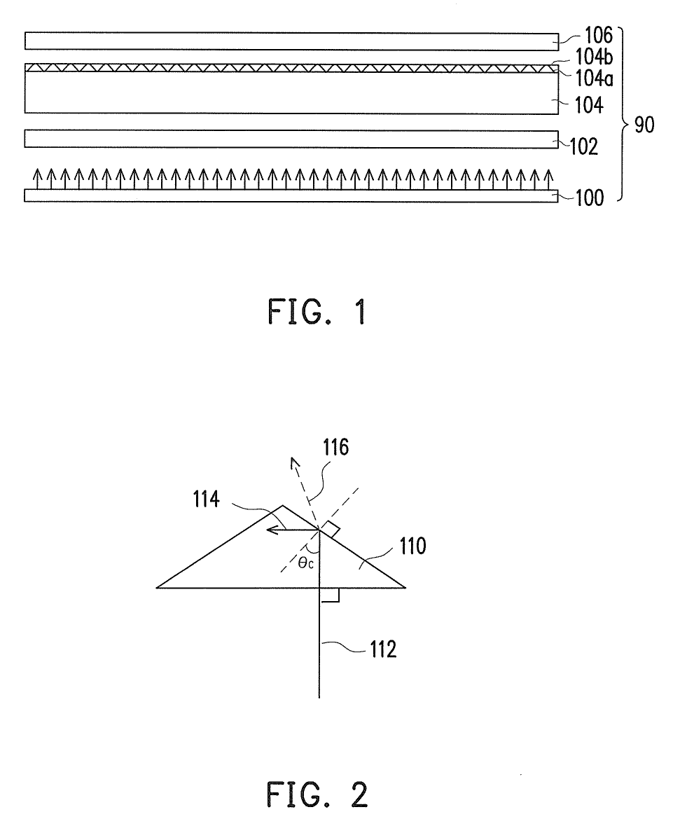

FIG. 1 is a cross-sectional view of a liquid crystal display (LCD) device according to an embodiment of the present invention. Referring to FIG. 1, the LCD device 90 includes a backlight source unit 100 for providing a light source. An optical function plate 102 receives the light source provided by the backlight source unit 100 and distributes the light source evenly onto a flat surface. A composite optical film 104 is disposed behind the optical function plate 102. The composite optical film 104 includes a base and an optical-field-modulation microstructure layer. The base has a light incident surface and a light emitting surface, wherein the light incident surface and the light emitting surface are correspondingly disposed. In the present embodiment, the light incident surface faces a surface of the optical function plate 102. The optical-field-modulation microstructure layer disposed on the light emitting surface is composed of dual-axis prism columns. The optical-field-modulation microstructure layer has two prism column sets which respectively include a plurality of first prism columns 104a and a plurality of second prism columns 104b, wherein the first prism columns 104a and the second prism columns 104b are respectively arranged in parallel, and the two prism column sets are disposed across each other. In the present embodiment, the first prism columns 104a and the second prism columns 104b are disposed perpendicular to each other, wherein the first prism columns 104a are extended in a direction perpendicular to the cross section, and the second prism columns 104b are extended in a direction parallel to the cross section. The structure of the composite optical film 104 will be described in detail below.

FIG. 2 is a diagram illustrating how a prism refracts an incident light. Referring to FIG. 2, because the refraction coefficient of the prism is greater than that of air, when an incident light 112 reaches the bottom of the prism 110 and the slope interface (i.e., the incident light 112 enters a medium having a low refractive index from a medium having a high refractive index), a critical angle θ_{c} is produced at the interface, wherein the critical angle θ_{c} can be calculated according to the well-known Snell's law, as following expression (1):

n₁ sin (θ_{c})=n₂ sin (90°). (1)

Wherein, n₁ is the refraction coefficient of the medium having the high refractive index, n₂ is the refraction coefficient of the medium having the low refractive index, and θ_{c} is the critical angle between the incident light beam and the normal on the incident surface. When the incident angle is greater than the critical angle θ_{c}, total internal reflection is produced, as denoted by the arrow 114, and when the incident angle is smaller than the critical angle θ_{c}, refraction is produced, as denoted by the arrow 116. Thus, the two slopes of the prism 110, and accordingly the light emitting range through this substrate, can be controlled by adjusting the vertex angle of the prism columns.

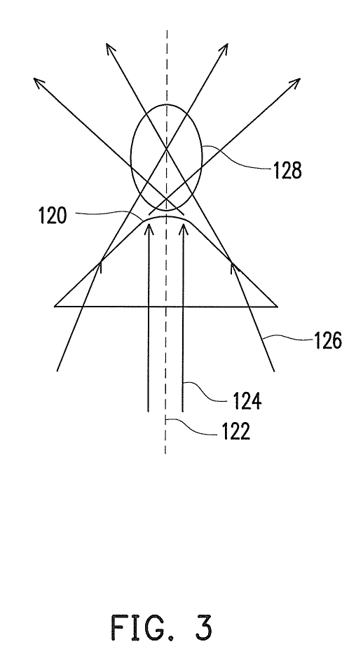

FIG. 3 is a diagram illustrating how a prism-like structure having a smooth curve top refracts an incident light according to an embodiment of the present invention. Referring to FIG. 3, if a prism-like structure having a curve top 120, for example, an aspheric curve structure, is used for replacing the prism having acute vertex angle, the light emitted can be fuzzed to certain extent. The dotted line indicates the central optical axis 122 of the prism-like structure. If the incident lights enters from different angles, such as a perpendicular incident light 124 and a diagonal incident light 126, because both sides of the prism-like structure are smooth surfaces, the emitted lights are concentrated toward the optical axis due to the smooth surfaces, so that the brightness around the axis is enhance. The curve top 120 can also fuzzed the incident lights to create a fuzzy area 128. Namely, the incident light are made uniform through the light collection function of the lens, and such a character can both concentrate and fuzz incident lights at large incident angles.

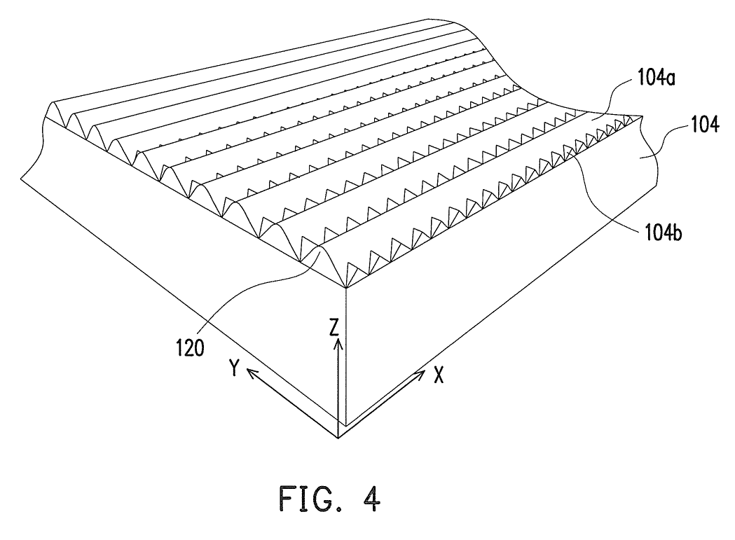

FIG. 4 is a perspective view of a composite optical film according to an embodiment of the present invention. Referring to FIG. 4, the composite optical film 104 includes a base and an optical-field-modulation microstructure layer. The base has a light incident surface and a light emitting surface, wherein the light incident surface and the light emitting surface are correspondingly disposed, and the light incident surface may be the bottom surface. The optical-field-modulation microstructure layer is disposed on the light emitting surface (i.e., the top surface). The optical-field-modulation microstructure layer includes a first prism column set, wherein the first prism column set has a plurality of first prism columns 104a arranged in parallel and extended along a first direction (i.e., the direction X as shown in FIG. 4). The optical-field-modulation microstructure layer further includes a second prism column set, wherein the second prism column set has a plurality of second prism columns 104b arranged in parallel and extended along a second direction (i.e., the direction Y as shown in FIG. 4). The first prism column set and the second prism column set are disposed across each other, and at least one of the first prism column set and the second prism column set has a smooth curve top 120.

In this embodiment, the first direction is perpendicular to the second direction. The first prism columns 104a have a smooth curve top 120, such as an aspheric curve. The second prism columns 104b are general prism structures having acute tips. The first prism columns 104a and the second prism columns 104b may have different heights and pitches. However, the structure illustrated in FIG. 4 is not intended for limiting the present invention. Herein pitch refers to the distance between the tops of two adjacent prism columns. The second prism columns 104b may also have smooth curve tops of different sizes. The light emitted by the first prism columns 104a enters the second prism columns 104b so that the luminous intensity slowly decreases when the viewing angle increases. As a result, a wider viewing angle is achieved compared to the conventional technique wherein a single prism sheet is adopted.

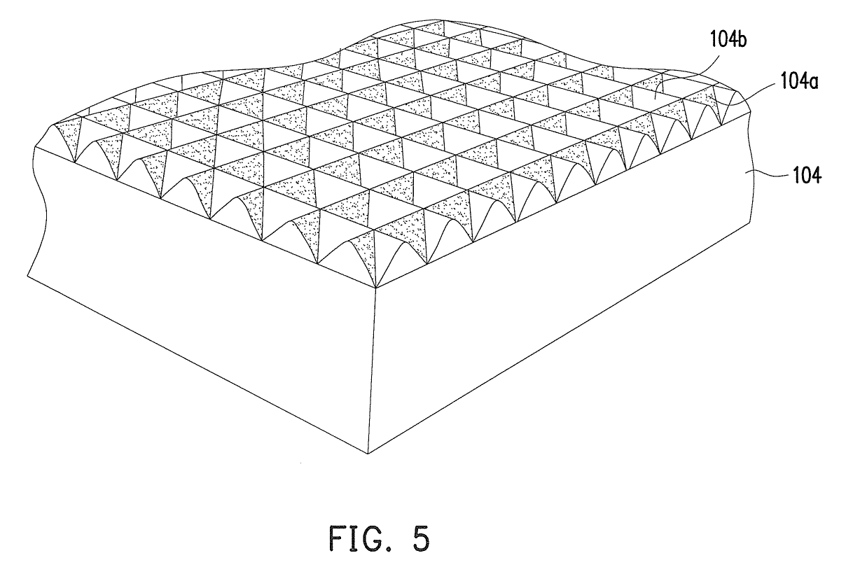

FIG. 5 is a perspective view of a composite optical film according to an embodiment of the present invention. Referring to FIG. 5, in the present embodiment, the first prism columns 104a and the second prism columns 104b have the same structure (i.e., have the same height and pitch) and are disposed perpendicular to each other.

In other words, the extension directions of the first prism columns 104a and the second prism columns 104b may cross each other at any angle. The first prism columns 104a and the second prism columns 104b respectively have a smooth curve top, or only one of the first prism columns 104a and the second prism columns 104b has a smooth curve top. Besides, the first prism columns 104a and the second prism columns 104b may have the same height or not all in the same height. In addition, the first prism columns 104a may have all in the same pitch or not all in the pitch, and the second prism columns 104b may have all in the same pitch or not all in the pitch. Moreover, the smooth curve top may be an aspheric curve. Furthermore, the composite optical film 104 may be combined with other optical function plates into a single optical composite plate according to the actual requirement.

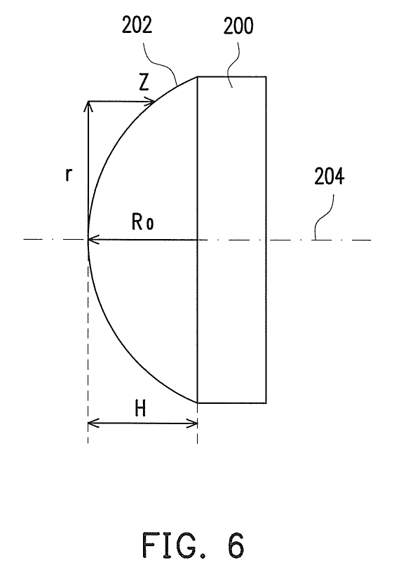

The basic angles of the prism columns are between 20° and 75°. The curvature radius of the aspheric curve top of the prism-like column is between 10 μm and 500 μm. FIG. 6 is a cross-sectional view of an aspheric curve according to an embodiment of the present invention. The aspheric column 202 on the substrate 200 is symmetrical around the central line 204, and the aspheric curve can be expressed with sag, as in following expression (2):

$$Z = \frac{{cr}^{2}}{1 + \sqrt{1 - ( 1 + k ) {c}^{2} {r}^{2}}} , \qquad ( 2 )$$

wherein c=1/R₀ represents the base curvature at vertex, k represents a conic constant, r represents the radial coordinate of the point on the surface, and H represents the height from the top of the aspheric curve to the surface of the substrate. Z represents the sag and which has different values at different positions. Foregoing expression (2) is used for determining the geometrical shape of the smooth curve on top of the prism columns. However, the expression (2) is not intended for limiting the smooth curve, and any smooth curve which can collect and uniform (fuzz) incident lights at large incident angles (as shown in FIG. 3) can be adopted.

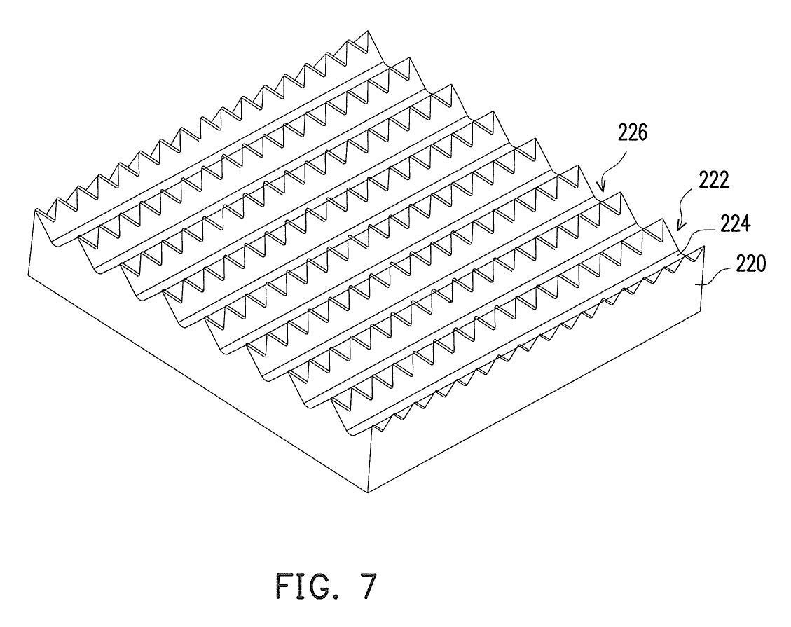

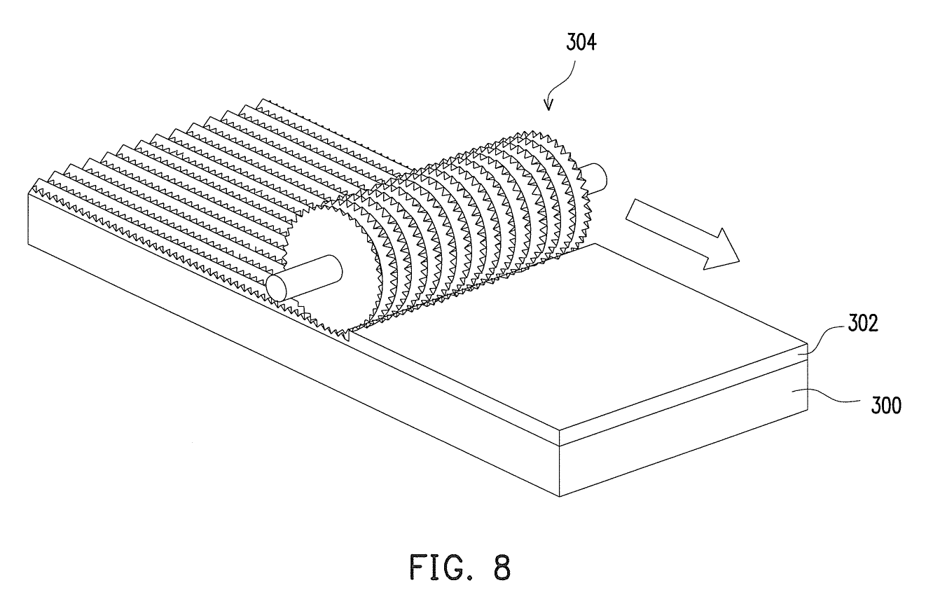

The composite optical film in the present invention can be fabricated through a pressing or a roll-to-roll method by using a suitable mold insert. FIG. 7 is a perspective view of a mold insert according to an embodiment of the present invention. Referring to FIG. 7, if the pressing method is adopted, a flat panel mold insert 220 is first fabricated, wherein a conformal structure corresponding to the prism columns as shown in FIG. 4 is already formed on the flat panel mold insert 220. The conformal structure includes a conformal concave structure 222 corresponding to the first prism columns 104a along the axis X and a conformal concave structure 226 corresponding to the second prism columns 104b along the axis Y. The conformal concave structure 222 has an aspheric curve 224 on the valley thereof. Accordingly, the smooth curve top 120 of the first prism columns 104a can be obtained.

The fabrication process will be described herein. First, a material layer for forming the prism column structure is fabricated on a substrate, wherein the substrate may be a transparent film or other film or plate with other optical functions. The prism column structure can be reprinted onto the substrate by directly pressing the substrate. This step may also be performed by coating a layer of adhesive on the substrate and pressing the adhesive by using the flat panel mold insert 220 before the adhesive dries up, so as to transform the prism column structure onto the substrate, and then solidifying the adhesive layer according to the feature of the adhesive (for example, through thermal solidification). Both of foregoing methods can be used for fabricating the prism column structure on a substrate.

Referring to FIG. 8, if the roll-to-roll method is adopted, after the material layer 302 is fabricated on the substrate 300, a roller mold insert 304 is rolled over the material layer 302. If the material layer 302 is made of a UV-solidified material, a UV light can be directly applied under the roller mold insert 302 to solidify the material layer, so as to simplify the fabrication process.

In other words, there are many methods for fabricating two prism column sets, and the present invention is not limited to the methods described above.

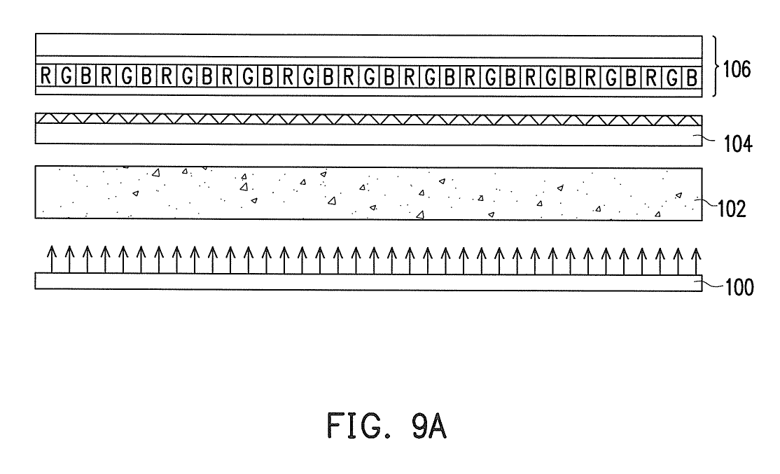

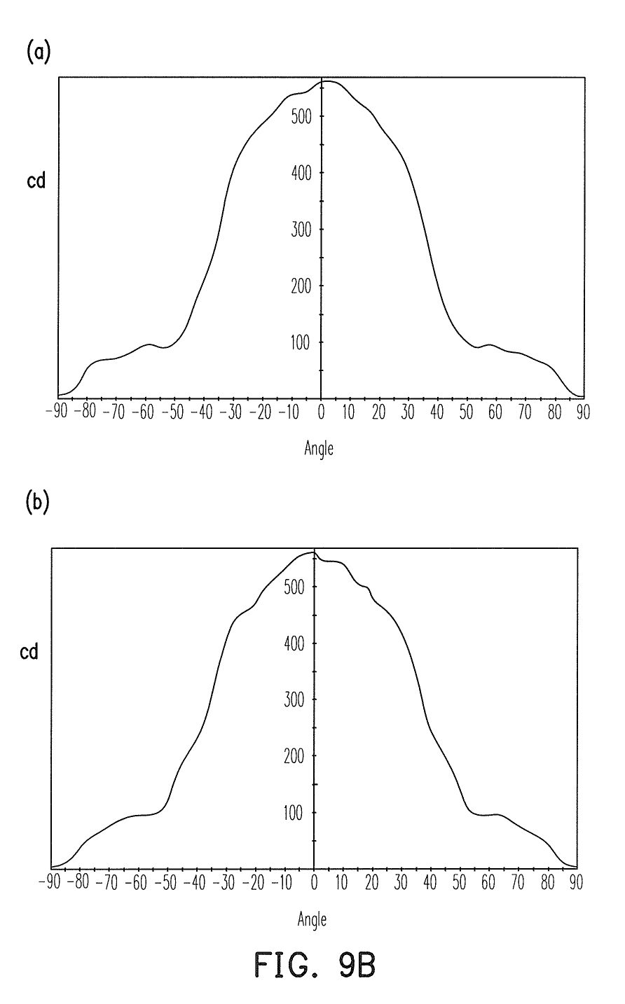

FIG. 9A is a cross-sectional view of an image display device having a composite optical film according to an embodiment of the present invention. FIG. 9B is a diagram illustrating the luminous intensity/viewing angle distribution of the image display device in FIG. 9A. Referring to FIG. 9A, a flat panel image display device includes a display panel 106 and a flat light source module. The flat light source module includes a backlight source unit 100 for providing a flat light source. The backlight source unit 100 may be a cold cathode fluorescent lamp (CCFL), a light emitting diode (LED), a small molecule organic light emitting diode (SMOLED), a polymer light emitting diode (PLED), an electro luminescent (EL), or a fluorescent flat light (FFL). In addition, the flat light source module further includes an optical function plate 102 and a composite optical film 104 for adjusting the optical field intensity of the emitted light, so as to improve the optical quality of the backlight source unit 100. The composite optical film 104 is disposed above the optical function plate 102. The optical function plate 102 may be a diffuser plate. The composite optical film 104 includes foregoing dual-axis prism structure as an optical-field-modulation microstructure layer.

Talking the structure illustrated in FIG. 4 as an example, FIG. 9B is a diagram illustrating the luminous intensity/viewing angle distribution of this structure. The vertical axis in FIG. 9B is in unit of candela (cd), which is corresponding to brightness (cd/m²). The distribution of brightness corresponding to angle can be understood from FIG. 9B. If the prism structure is design to has the aspheric prism column structure along axis X, the aspheric curve is expressed with foregoing expression (2), wherein R₀=1/c=3 μm, k=−1.76, pitch=50 μm, and H is the height from the top of the aspheric curve to the surface of the substrate and H=25 μm. In addition, the prism structure is along the axis Y, wherein pitch=40 μm, H is the height from the vertex of the prism to the surface of the substrate and H=20 μm. FIG. 9B(a) illustrates the viewing angle distribution on YZ plane, and FIG. 9B(b) illustrates the viewing angle distribution on XZ plane. According to FIG. 9B, when the viewing angle exceeds 50°, even though the luminous intensity still decreases, it won't drop to zero, and no drastic variation in the luminous intensity is produced.

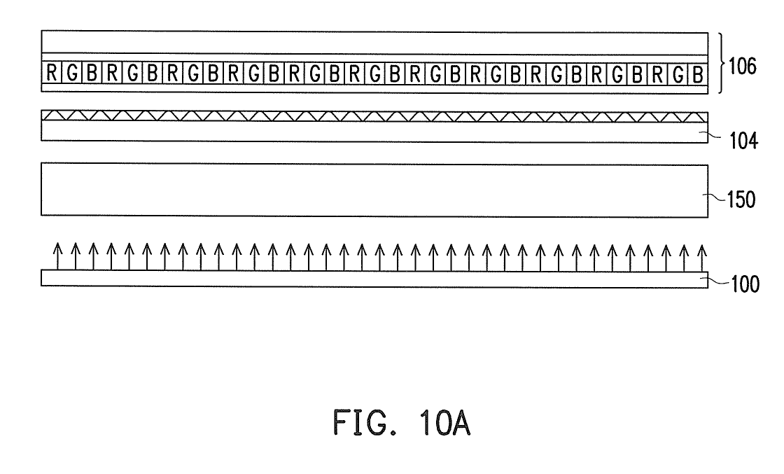

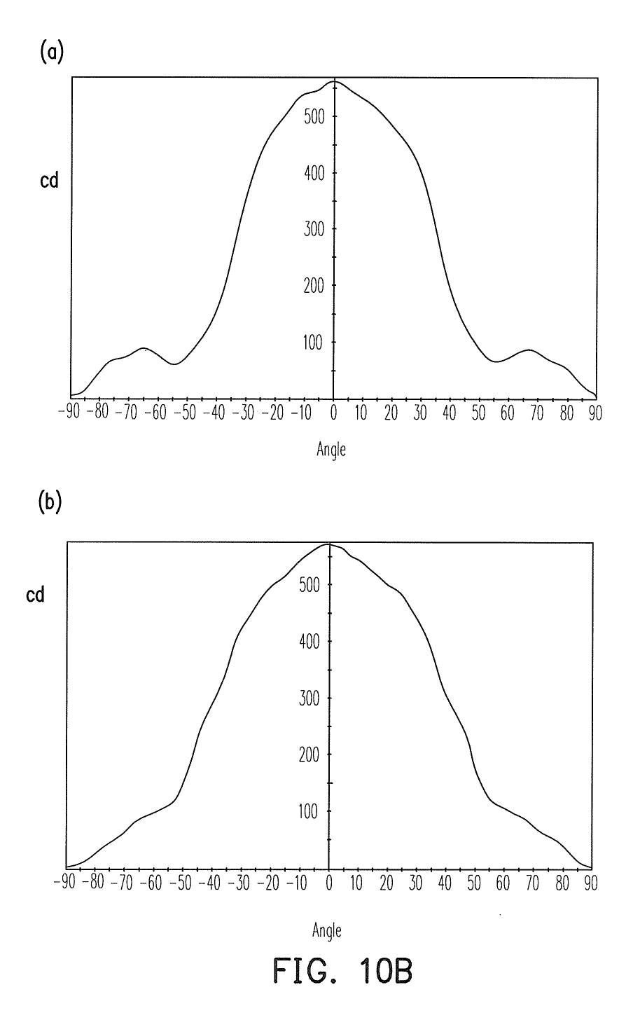

FIG. 10A is a cross-sectional view of an image display device having a composite optical film according to an embodiment of the present invention. FIG. 10B is a diagram illustrating the luminous intensity/viewing angle distribution of the image display device in FIG. 10A. Referring to FIG. 10A, in the present embodiment, the optical function plate 102 illustrated in FIG. 9A is altered. As shown in FIG. 10A, the composite optical film 104 is disposed on a transparent supporting plate 150.

FIG. 10B illustrates the luminous intensity distribution at different viewing angles in the image display device-in FIG. 10A. If the prism structure is designed to have an aspheric prism column structure along axis X, the aspheric curve is expressed with foregoing expression (2), wherein R₀=1/c=3 μm, k=−1.76, pitch=50 μm, and H is the height from the top of the aspheric curve to the surface of the substrate and H=25 μm. In addition, the prism structure is along the axis Y, wherein pitch=25 μm, H is the height from the prism tip to the surface of the substrate and H=12.5 μm. FIG. 10B(a) illustrates the viewing angle distribution on YZ plane. FIG. 10B(b) illustrates the viewing angle distribution on XZ plane. According to FIG. 10B, when the viewing angle exceeds 50°, even though the luminous intensity decrease, it won't drop to zero, and no drastic variation in the luminous intensity is produced.

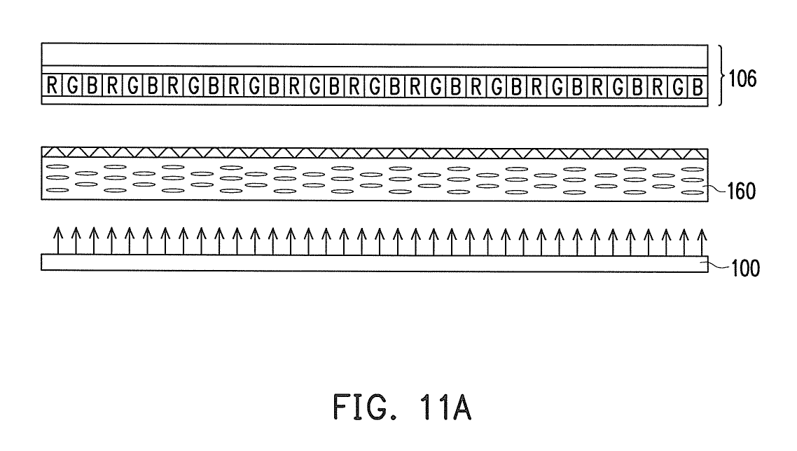

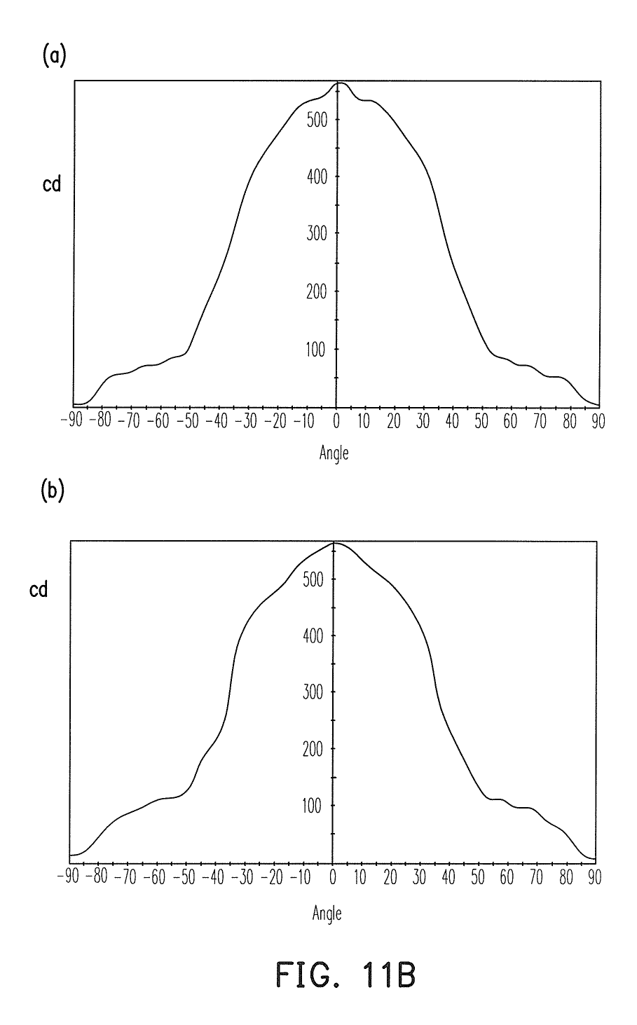

FIG. 11A is a cross-sectional view of an image display device having a composite optical plate according to an embodiment of the present invention. FIG. 11B is a diagram illustrating the luminous intensity/viewing angle distribution of the image display device in FIG. 11A. Referring to FIG. 11A, in the present embodiment, the composite optical film 104 and the optical function plate 102 in FIG. 9A are combined together, namely, the dual-axis prism structure on the composite optical film 104 is directly disposed on a diffuser plate to form a composite optical plate 160, wherein the substrate of the composite optical plate 160 may be made of a diffusing material.

FIG. 11B illustrates the luminous intensity at different viewing angles in the image display device in FIG. 11A. If the prism structure is designed to have an aspheric prism column structure along the axis X, the aspheric curve is expressed with foregoing expression (2), wherein R₀=1/c=51 μm, k=−1.6, pitch=50 μm, and H is the height from the top of the aspheric curve to the surface of the substrate and H=25 μm. Besides, the prism structure is along axis Y, wherein pitch=50 μm, H is the height from the prism tip to the surface of the substrate and H=25 μm. FIG. 11B(a) illustrates the viewing angle distribution on YZ plane, and FIG. 11B(b) illustrates the viewing angle distribution on XZ plane. According to FIG. 11B, when the viewing angle exceeds 50°, even though the luminous intensity decreases, it won't drop to zero, and no drastic variation in the luminous intensity is produced.

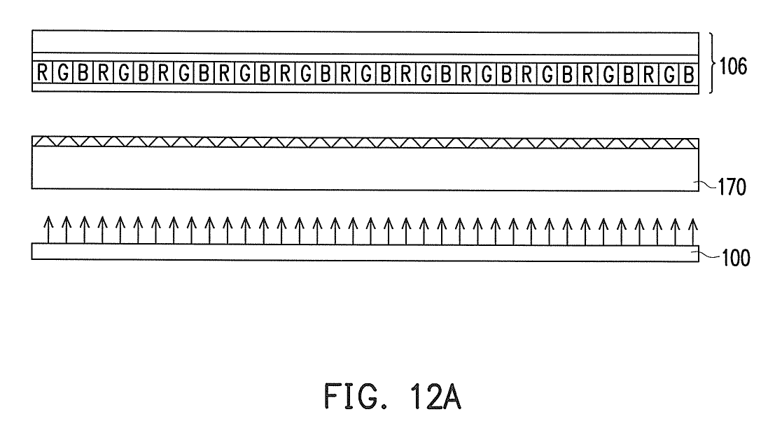

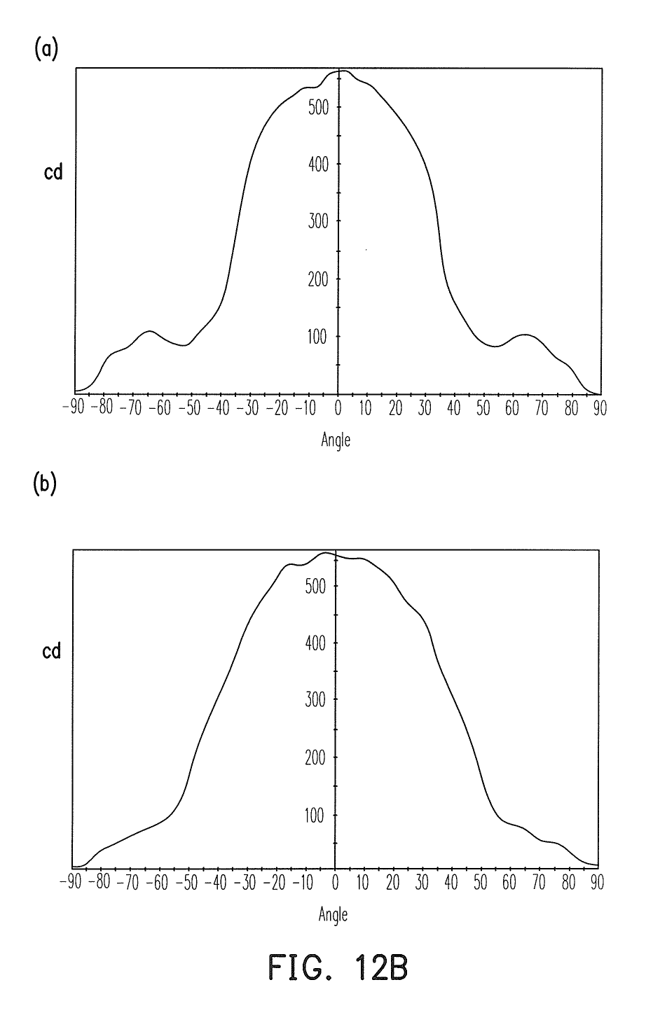

FIG. 12A is a cross-sectional view of an image display device having a composite optical plate according to an embodiment of the present invention. FIG. 12B is a diagram illustrating the luminous intensity/viewing angle distribution of the image display device in FIG. 12A. Referring to FIG. 12A, in the present embodiment, the composite optical film 104 and the transparent supporting plate 150 in FIG. 10A are combined together, namely, the dual-axis prism structure on the composite optical film 104 is directly disposed on the transparent supporting plate 150 to form a composite optical plate 170, wherein the substrate of the composite optical plate 170 may be a transparent substrate.

FIG. 12B illustrates the luminous intensity at different viewing angles in the image display device in FIG. 12A. If the prism structure is designed to have an aspheric curve prism structure along the axis X, the aspheric curve is expressed with foregoing expression (2), wherein R₀=1/c=3 μm, k=−1.76, pitch=50 μm, and H is the height from the top of the aspheric curve to the surface of the substrate and H=25 μm. In addition, the axis Y also has an aspheric prism column structure, wherein R₀=1/c=3 μm, k=−1.52, pitch=25 μm, and H=12.5 μm. FIG. 12B(a) illustrates the viewing angle distribution on YZ plane, and FIG. 12B(b) illustrates the viewing angle distribution on XZ plane. According to FIG. 12B, when the viewing angle exceeds 50°, even though the luminous intensity decreases, it won't drop to zero, and no drastic variation in the luminous intensity is produced.

As described above, the composite optical film provided by the present invention can increase the viewing range and does not produce any drastic variation at large viewing angles.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A composite optical film, comprising:
a base, having a light incident surface and a light emitting surface, wherein the light incident surface and the light emitting surface are correspondingly disposed; and
an optical-field-modulation microstructure layer, disposed on the light emitting surface, wherein the optical-field-modulation microstructure layer comprises:
a first prism column set, having a plurality of first prism columns arranged in parallel and extended along a first direction; and
a second prism column set, having a plurality of second prism columns arranged in parallel and extended along a second direction,
wherein the first prism column set and the second prism column set are disposed across each other, and at least one of the first prism column set and the second prism column set has a smooth curve top.

2. The composite optical film according to claim 1, wherein the first prism columns and the second prism columns respectively have the smooth curve top.

3. The composite optical film according to claim 1, wherein one of the first prism column set and the second prism column set has the smooth curve top, and another one of the first prism column set and the second prism column set has a top composed of prism tips.

4. The composite optical film according to claim 1, wherein the first prism columns and the second prism columns are all in same height or not all in same height.

5. The composite optical film according to claim 1, wherein the first prism columns have a same first height, the second prism columns have a same second height, and the first height is different from the second height.

6. The composite optical film according to claim 1, wherein the first prism columns are all in same pitch or not all in same pitch.

7. The composite optical film according to claim 1, wherein the second prism columns are all in same pitch or not all in same pitch.

8. The composite optical film according to claim 1, wherein the smooth curve top is an aspheric curve.

9. The composite optical film according to claim 1, wherein the first direction is perpendicular to the second direction.

10. The composite optical film according to claim 1 further comprising an optical function plate, wherein the optical function plate is combined with the base into a composite optical plate.

11. The composite optical film according to claim 10, wherein the optical function plate comprises a transparent supporting plate or a diffuser plate.

12. A flat light source module, comprising:
a backlight source unit, for providing a flat light source; and
a composite optical film, disposed at one side of the backlight source unit for directly or indirectly receiving the flat light source, wherein the composite optical film comprises:
a base, having a light incident surface and a light emitting surface, wherein the light incident surface and the light emitting surface are correspondingly disposed, and the light incident surface faces the backlight source unit; and
a first prism column set, having a plurality of first prism columns located on the light emitting surface, wherein the first prism columns are arranged in parallel and extended along a first direction; and
a second prism column set, having a plurality of second prism columns located on the light emitting surface, wherein the second prism columns are arranged in parallel and extended along a second direction,
wherein the first prism column set and the second prism column set are disposed across each other, and at least one of the first prism column set and the second prism column set has a smooth curve top.

13. The flat light source module according to claim 12, wherein the first prism columns and the second prism columns respectively have the smooth curve top.

14. The flat light source module according to claim 12, wherein one of the first prism column set and the second prism column set has the smooth curve top, and another one of the first prism column set and the second prism column set has a top composed of prism tips.

15. The flat light source module according to claim 12, wherein the first prism columns and the second prism columns are all in same height or not all in same height.

16. The flat light source module according to claim 12, wherein the first prism columns has a same first height, the second prism columns has a same second height, and the first height is different from the second height.

17. The flat light source module according to claim 12, wherein the first prism columns are all in same pitch or not all in same pitch.

18. The flat light source module according to claim 12, wherein the second prism columns are all in same pitch or not all in same pitch.

19. The flat light source module according to claim 12, wherein the smooth curve top is an aspheric curve.

20. The flat light source module according to claim 12, wherein the first direction is perpendicular to the second direction.

21. The flat light source module according to claim 12 further comprising an optical function plate, wherein the optical function plate is combined with the base into a composite optical plate.

22. The flat light source module according to claim 21, wherein the optical function plate comprises a transparent supporting plate or a diffuser plate.

23. The flat light source module according to claim 21 being combined with a display panel into a flat image display device.
